(19) United States
(12) Patent Application Publication
(10) Pub. No.: US 2005/0157920 A1
(43) Pub. Date: Jul. 21, 2005

(54) Machine vision system and method

(76) Inventors: John Doherty, Blackrock (IE); James Mahon, Glasnevin (IE)

Correspondence Address: Paul D. Greeley, Esq.;Ohlandt, Greeley, Ruggiero & Perle, L.L.P., 10th Floor, One Landmark Square, Stamford, CT, 06901-2682, US

(21) Appl. No.: 10/892,966

(22) Filed: Jul. 16, 2004

(30) Foreign Application Priority Data
Jan. 21, 2004 (IE) 2004/0034

(51) Int. Cl. G06K 9/00

(52) U.S. Cl. 382/145

(57) ABSTRACT

A machine vision system comprising a structured light illuminator, a camera, an image processor, and a controller, wherein the controller dynamically adjusts parameters for structured illumination according to actual position of a subject being inspected.

The invention relates to machine vision systems.

Our prior European Patent Specification No. EP0935135A1 describes use of structured illumination for three-dimensional inspection. A structured line of light forms a linear pattern on the circuit board, the pattern of the line indicating height of components.

While such an approach is effective, problems can arise where the alignment of deposits or components being inspected is not as it is expected.

The invention is therefore directed towards providing an improved machine vision system and method.

### STATEMENTS OF INVENTION

According to the invention, there is provided a machine vision system comprising a structured light illuminator, a camera, an image processor, and a controller, wherein the controller dynamically adjusts parameters for structured illumination according to actual position of a subject being inspected.

In one embodiment, the subject is a circuit and the parameters are adjusted on a per-component basis.

In another embodiment, the actual position is determined by capturing an on-axis image normal to the subject.

In a further embodiment, the image processor performs separate processing for each adjustment of the parameters.

In one embodiment, the structured illumination parameters are adjusted by control of the illuminator.

In another embodiment, the illuminator comprises a dynamically adjustable reflective device and the controller controls operation of the device to adjust the illuminator parameters.

In a further embodiment, the device is a digital mirror device.

In one embodiment, the parameters are adjusted to provide a desired direction for a line or lines of structured illumination.

In another embodiment, the lines are dynamically adjusted to have a desired angle which respect to a feature of an electronic component.

In a further embodiment, the system comprises at least one off-axis camera for capturing images for processing, the structured illumination being on-axis.

In one embodiment, the off-axis camera is mounted according to the Scheimpflug principle.

In another embodiment, the controller sets initial parameters according to nominal subject position data.

In a further embodiment, the subject is a circuit and the nominal position data is CAD data.

### DETAILED DESCRIPTION OF THE INVENTION

The invention will be more clearly understood from the following description of some embodiments thereof, given by way of example only with reference to the accompanying drawings in which:—

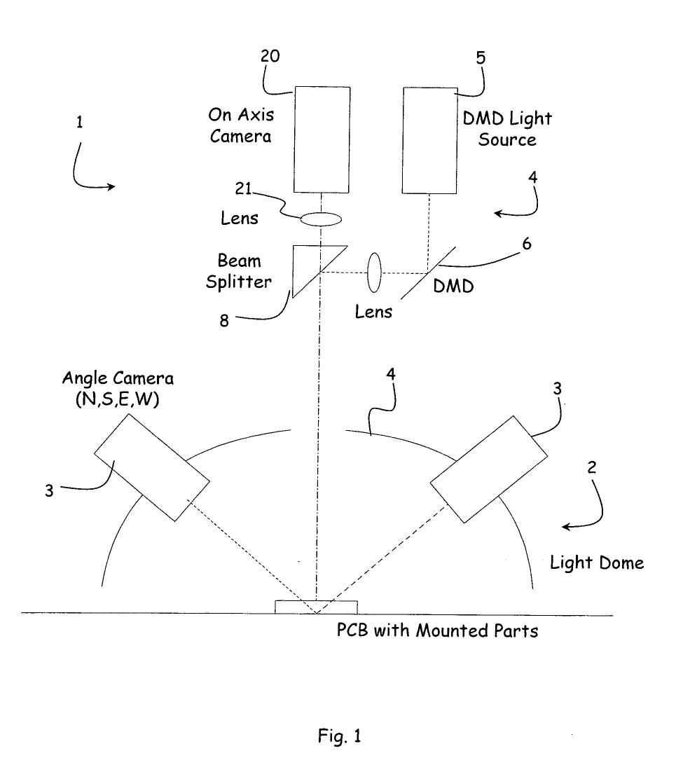

FIG. 1 is a diagrammatic view of a machine vision system head;

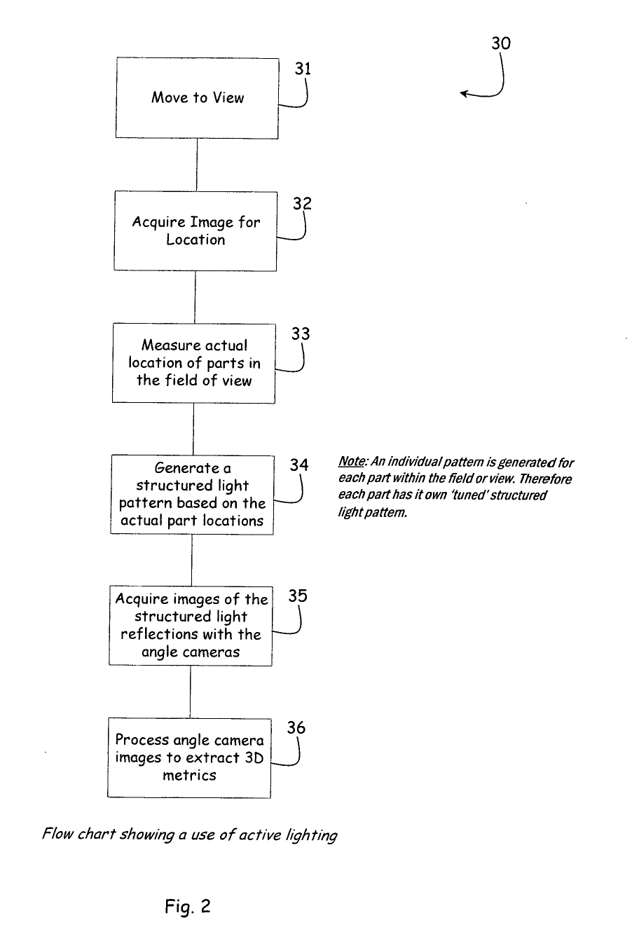

FIG. 2 is a flow diagram for operation of the system;

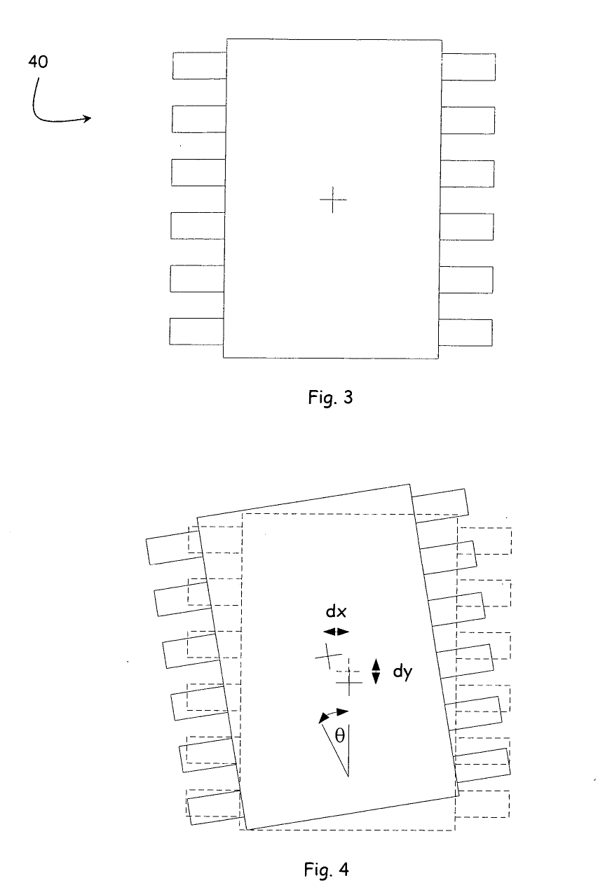

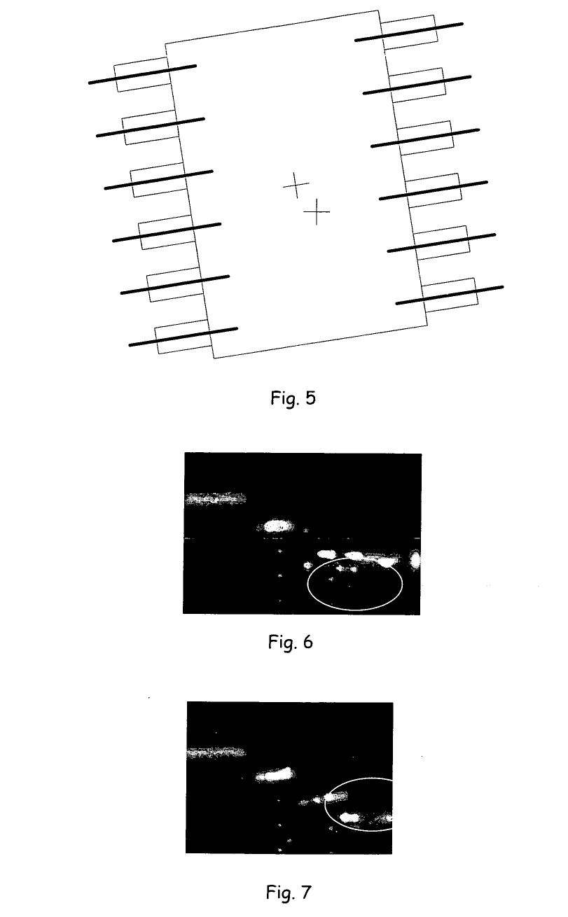

FIGS. 3 to 5 are diagrams illustrating illumination parameters;

FIGS. 6 and 7 are photographs showing a comparison between prior art illumination and illumination according to the invention; and

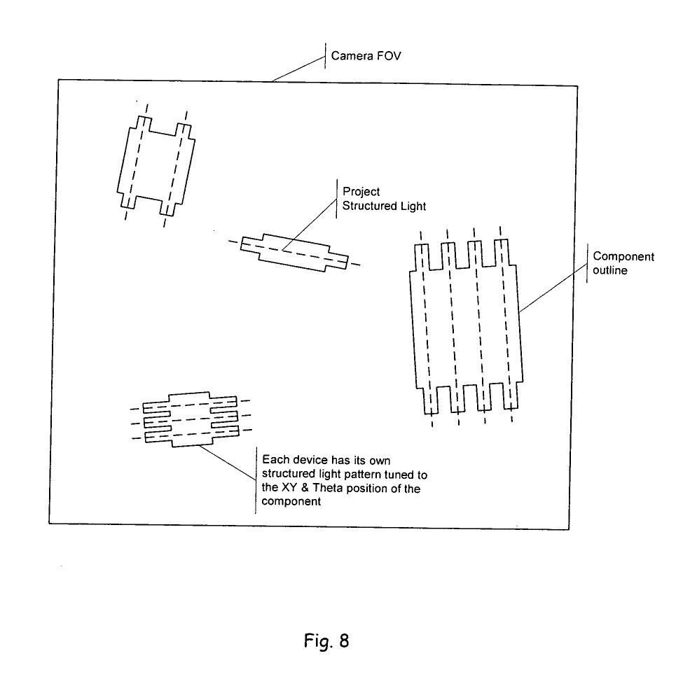

FIG. 8 is a set of diagrams illustrating how each device on a board has its own individual structured light pattern.

Referring to FIG. 1, a head 1 of a machine vision system is shown. The head 1 comprises a scene illuminator 2 of domed shape having openings for four cameras 3 at N, S, E and W locations in plan and at angles of 45° C. to 60° to horizontal. The dome 2 comprises a top opening 4 for structured illumination.

The structured illumination is generated by a programmable structured lighting unit 4 comprising a light source 5 directing a line of light to a digital mirror device (DMD) 6. Illumination is provided by a single intense flat field source comprising individual solid-state devices that are diffused and which if projected directly at the object would illuminate the entire surface (i.e. would provide illumination for the entire FOV of the camera). The DMD 6 consists of a set of individually controlled mirrored surfaces. By manipulating each of these mirrors the DMD 6 has the ability to create reflected patterns. It is these patterns (in the form of lines) which are reflected through a lens 7 and onto a beam splitter 8.

An on-axis camera 20 receives reflected light via the beam splitter 8 and a lens 21. Thus, the off-axis cameras 3 capture images with structured illumination on-axis from the beam splitter 8, and the on-axis camera 20 captures images with uniform illumination from the scene illuminator 2.

Referring to FIG. 2, operation of the head is illustrated in flow diagram format as a method 30. In a step 31 the head is moved to the viewing position and the structured illuminator 4 is adjusted (“tuned”) according to prior knowledge of the nominal scene. This knowledge is provided by CAD data, including component size, numbers of leads, and lead size for example.

In step 32, the scene illuminator and the camera 20 are used to capture a 2D image of the scene.

In step 33 an image processor measures actual location of individual parts in the field of view.

In step 34 the image processor instructs a controller to generate a structured light pattern based on the actual part locations. This is performed per-part so that the direction of the line of illumination is orthogonal to an actual axial direction of each part. Thus, the system dynamically compensates for skewing (and XY Offset) of individual parts on a per-part basis.

In step 35 various images are captured using the cameras 3. These images are processed in step 36 to extract 3D metrics.

FIG. 3 shows a nominal position of a component 40, whereas FIG. 4 shows the actual position. The processor determines from the initial image the component offset and skew values dx, dy, and θ values are determined. FIG. 6 shows an example the profile of a good lead (highlighted), generated with line generated by the active structure light source through the middle of a component lead is view off-axis by an angled camera.

FIG. 7 shows an example of the profile of a lifted lead (highlighted), generated with a line generated by the active structure light source through the middle of a component lead is view off-axis by an angled camera.

FIG. 8 shows diagrammatically the fact that there is per-component dynamically adjusted structured illumination for optimum information gathering.

Use of the DMD 6 allows the structured illumination to be fully programmable and dynamically controlled in real time, as it comprises a 2D array of individually addressable mirrors, with individual pixel-level control.

It will be appreciated that the system provides 2D, 3D, and angled viewing within the one system. The 2D image information provides a high degree of accuracy for 2D measurements like (x,y) offset and skew. The 3D image information provides a high degree of accuracy for 3D measurements such as height and volume. The angle cameras provide the capability of view features normally hidden from view by an on-axis camera. The system also has the ability to illuminate the exact areas of interest in a scene with the optimum lighting pattern, reducing the amount of image data needed to be processed resulting in greater efficiency in the image processing. Traditional 3D systems tend to produce 3D data for the entire field of view. In this system 3D data is only produced from those areas where 3D data is required. In the invention, the system only re-constructs the particular relevant information, greatly reducing the extent of data to be processed.

Also, a large number of parts in a scene with different ‘tuned’ lighting patterns can easily be generated.

The DMD structured lighting unit can also be used as an on-axis lighting unit to provide uniform on-axis scene lighting across the field of view. Modulating the mirrors can vary the intensity of the light. Light uniformity across the field of view (flat field correction) can be compensated for by the DMD by modulating the mirrors for the edge of the field of view differently from the centre.

Also, coloured light can be generated by using a spinning colour wheel with a single white light source. The wheel would be placed between the light source and the DMD and would be synchronised to the camera acquisition sequence. Each snap for RGB would require the wheel to rotate to the next colour in the RGB sequence.

The invention is not limited to the embodiments described but may be varied in construction and detail.

In order for 3D information to be extracted it is necessary that an angle be established between the illumination source and the camera which acquires an image of the project illumination on the object surface. In the arrangement described above illumination is provided orthogonal to the object surface and is imaged by angled cameras (N, S, E & W). An alternative arrangement is to project the structured light pattern at an angle. In this arrangement a single camera only may be sufficient.

Also, the structured illumination may be provided by any programmable illuminator which can be dynamically controlled. For example, a selectively transmissive device such as an array of pixels selectively allowing transmission of light may be used instead of a reflective device.

Also, the structured illumination need not be linear, any desired pattern such as gridded being possible.

1. A machine vision system comprising a structured light illuminator, a camera, an image processor, and a controller, wherein the controller dynamically adjusts parameters for structured illumination according to actual position of a subject being inspected.

2. A machine vision system as claimed in claim 1, wherein the subject is a circuit and the parameters are adjusted on a per-component basis.

3. A machine vision system as claimed in claims 1, wherein the actual position is determined by capturing an on-axis image normal to the subject.

4. A machine vision system as claimed in claim 1, wherein the image processor performs separate processing for each adjustment of the parameters.

5. A machine vision system as claimed in claim 1, wherein the structured illumination parameters are adjusted by control of the illuminator.

6. A machine vision system as claimed in claim 5, wherein the illuminator comprises a dynamically adjustable reflective device and the controller controls operation of the device to adjust the illuminator parameters.

7. A machine vision system as claimed in claim 6, wherein the device is a digital mirror device.

8. A machine vision system as claimed in claim 1, wherein the parameters are adjusted to provide a desired direction for a line or lines of structured illumination.

9. A machine vision system as claimed in claim 8, wherein the lines are dynamically adjusted to have a desired angle which respect to a feature of an electronic component.

10. A machine vision system as claimed in claim 1, wherein the system comprises at least one off-axis camera for capturing images for processing, the structured illumination being on-axis.

11. A machine vision system as claimed in claim 10, wherein the off-axis camera is mounted according to the Scheimpflug principle.

12. A machine vision system as claimed in claim 1, wherein the controller sets initial parameters according to nominal subject position data.

13. A machine vision system as claimed in claim 12, wherein the subject is a circuit and the nominal position data is CAD data.

14. (canceled)
